(19) United States
(12) Patent Application Publication
(10) Pub. No.: US 2016/0108869 A1
(43) Pub. Date: Apr. 21, 2016

(54) INTAKE AIR COOLING SYSTEM IN ENGINE

(71) Applicant: Hyundai Motor Company, Seoul (KR)

(72) Inventor: Won Sup KIM, lncheon (KR)

(73) Assignee: Hyundai Motor Company, Seoul (KR)

(21) Appl. No.: 14/737,743

(22) Filed: Jun. 12, 2015

(30) Foreign Application Priority Data
Oct. 21, 2014 (KR) 10-2014-0142836

(51) Int. Cl. F02M 35/10; F01D 25/12; F02B 29/04; F02M 35/104

(52) U.S. Cl. CPC F02M 35/10268; F02M 35/104; F01D 25/12; F02B 29/0462; F02B 29/0443; F02M 25/0709

(57) ABSTRACT

An intake air cooling system in an engine may include: an intake manifold; a connection passage in communication with the intake manifold; an intake passage provided in communication with the connection passage; a compressor provided for compressing the outdoor air passed through the intake passage and forwarding the outdoor air compressed thus to the connection passage as the intake air; an intercooler arranged on the connection passage for cooling the outdoor air compressed by the compressor with cooling water; a low temperature radiator for dispersing heat remaining in the cooling water passed through the intercooler to air; a cooling water passage arranged to circulate the cooling water while passing through the low temperature radiator, the compressor, and the intercooler in succession, and a water pump for pumping the cooling water to circulate it along the cooling water passage.

### CROSS-REFERENCE TO RELATED APPLICATION

The present application claims priority to and the benefit of Korean Patent Application No. 10-2014-0142836 filed on Oct. 21, 2014, the entire contents of which is incorporated herein for all purposes by this reference.

### BACKGROUND OF THE INVENTION

1. Field of the Invention

The present invention relates to an intake air cooling system in an engine. More particularly, the present invention relates to an intake air cooling system in an engine for cooling intake air with water.

2. Description of Related Art

In general, an engine combusts a mixed gas in a combustion chamber, to use heat energy from the combustion for operation. In this case, the mixed gas is a mixture of air and fuel, and the engine is provided with an intake manifold for supplying the mixture or the fuel and the air to each cylinder.

The engine is provided with an intake passage for supplying outdoor air or recirculated exhaust gas to the intake manifold. The outdoor air or the recirculated exhaust gas may be supplied to the intake manifold via a compressor of a turbocharger and an intercooler. In this case, a system for cooling the recirculated high temperature exhaust gas and a system for cooling the compressed high temperature outdoor air are required.

However, if the systems for cooling the outdoor air or the recirculated exhaust gas are complicated, production cost increases, weight increases, and fuel consumption is liable to become poor.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an intake cooling system in an engine having an advantage of a simple structure.

Accordingly, an object of the present invention created for solving the above problem is to provide an intake air cooling system in an engine which makes a system thereof simple while maintaining cooling performance.

To achieve the object of the present invention, an intake air cooling system in an engine for cooling intake air supplied to a cylinder of the engine may include: an intake manifold provided for guiding the intake air to the cylinder; a connection passage in communication with the intake manifold for introducing the intake air to the intake manifold; an intake passage provided for receiving the outdoor air and in communication with the connection passage; a compressor provided for compressing the outdoor air passed through the intake passage and forwarding the outdoor air compressed thus to the connection passage as the intake air; an intercooler arranged on the connection passage for cooling the outdoor air compressed by the compressor with cooling water; a low temperature radiator for dispersing heat remaining in the cooling water passed through the intercooler to air; a cooling water passage arranged to circulate the cooling water while passing through the low temperature radiator, the compressor, and the intercooler in succession, and a water pump for pumping the cooling water to circulate it along the cooling water passage.

The system may further include an exhaust manifold provided for receiving the exhaust gas from the cylinder, an exhaust passage in communication with the exhaust manifold for exhausting the exhaust gas passed through the exhaust manifold, and a recirculation passage which is a branch from the exhaust passage in communication with the connection passage for recirculating a portion of the exhaust gas passing through the exhaust passage as the intake air.

The compressor may compress the outdoor air passed through the intake passage and the recirculated exhaust gas passed through the recirculation passage, and forward the outdoor air and the recirculated exhaust gas compressed thus to the connection passage as the intake air.

The intercooler may cool the outdoor air and the recirculated exhaust gas compressed thus by the compressor.

The cooling water passage may include an inflow line formed such that the cooling water passed through the intercooler and the low temperature radiator is introduced to the compressor, an outflow line formed such that the cooling water passed through the compressor is discharged from the compressor, and a circulating line formed to be in communication with the inflow line and the outflow line for the cooling water introduced to the compressor through the inflow line to circulate inside of the compressor.

The circulating line may be formed in a body of the compressor for the cooling water to exchange heat with the air passing through the compressor.

The circulating line may be a passage formed in a ring shape along the body of the compressor.

The compressor may include an outdoor air inlet formed for receiving the outdoor air introduced to the intake passage, an exhaust gas inlet formed for receiving the recirculated exhaust gas introduced to the recirculation passage, and an air outlet formed for discharging the outdoor air and the recirculated exhaust gas compressed as the outdoor air, and the recirculated exhaust gas passes through the compressor to the connection passage.

The cooling water passage may form an inflow line for introduction of the cooling water passed through the intercooler and the low temperature radiator to the compressor, an outflow line for discharging the cooling water passed through the compressor from the compressor, and a circulating line for the cooling water introduced to the compressor through the inflow line to circulate inside of the compressor.

The circulating line may be formed in the body of the compressor such that the cooling water passing through the circulating line exchanges heat with the air passing through the outdoor air inlet, the exhaust gas inlet, and the air outlet without flow interference with the air passing through the outdoor air inlet, the exhaust gas inlet, and the air outlet.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 illustrates a schematic view of an intake air cooling system in an engine in accordance with a preferred embodiment of the present invention.

FIG. 2 illustrates a perspective view of a compressor in accordance with a preferred embodiment of the present invention.

FIG. 3 illustrates a cross-sectional view across a line A-A in FIG. 2.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

An exemplary embodiment of the present invention will hereinafter be described in detail with reference to the accompanying drawings.

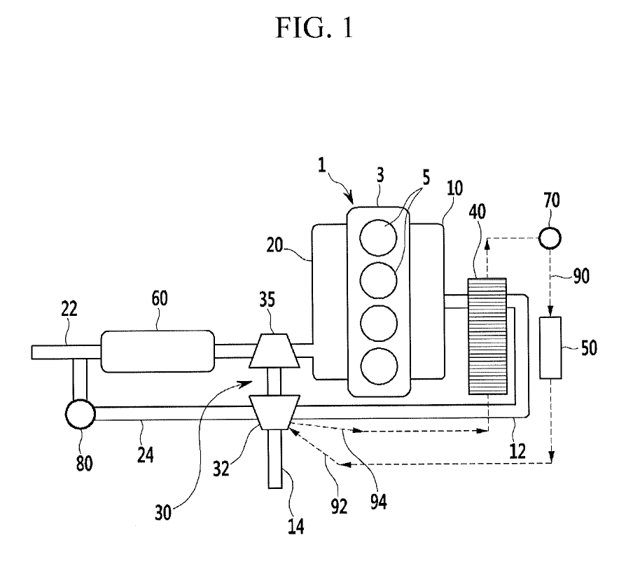

FIG. 1 illustrates a schematic view of an intake air cooling system in an engine in accordance with a exemplary embodiment of the present invention.

Referring to FIG. 1, the intake air cooling system in an engine includes an intake manifold 10, a connection passage 12, an intake passage 14, a recirculation passage 24, a compressor 32, an intercooler 40, a cooling water passage 90, and a water pump 70.

The intake manifold 10 is a passage for guiding the intake air to a plurality of cylinders 5 formed in a cylinder block 3 of the engine 1, which is apparent to a person of ordinary skill in the art.

The connection passage 12 is a passage of the intake air in communication with the intake manifold 10 for introducing the intake air to the intake manifold 10.

The intake passage 14 is an intake air passage provided for receiving the outdoor air and that is in communication with the connection passage 12.

The recirculation passage 24 is a branch from an exhaust passage 22 which is in commutation with an exhaust manifold 20 for exhausting the exhaust gas outside of the engine. The recirculation passage 24 is in communication with the connection passage 12. Moreover, the recirculation passage 24 functions to recycle a portion of the exhaust gas passed through the exhaust passage 22 as intake air to the engine. In this case, the exhaust passage 22 may be provided to pass through a turbine 35 of a turbocharger 30 and an after-treatment unit 60 in succession. In the meantime, it is apparent to a person of ordinary skill in the art that the exhaust manifold 20 is a passage for receiving the exhaust gas from the plurality of cylinders formed in the cylinder block 3 of the engine 1, and the after-treatment unit 60 is an apparatus for removal or reduction of pollutants from the exhaust gas.

An exhaust gas recirculation valve 80 is arranged on the recirculation passage 24. The exhaust gas recirculation valve 80 opens/closes the recirculation passage 24 to control a recirculating time of the exhaust gas and a recirculating rate of the recirculated exhaust gas.

The compressor 32 is positioned at a crossing point of the connection passage 12, the intake passage 14, and the recirculation passage 24. That is, the compressor 32 is in communication with the connection passage 12, the intake passage 14, and the recirculation passage 24. The compressor 32 forwards the outdoor air passed through the intake passage 14 and the recirculated exhaust gas passed through the recirculation passage 24 to the connection passage 12 as the intake air to the engine 1.

In the meantime, the turbocharger 30 includes the compressor 32 and the turbine 35. The turbine 35 is connected to the exhaust manifold 20 so as to be rotated by an exhaust gas flow.

The compressor 32 compresses the outdoor air and the exhaust gas respectively forwarded thereto from the intake passage 14 and the recirculation passage 24 owing to the torque of the turbine 35, and supplies the outdoor air and the exhaust gas compressed thus to the engine 1. Since the turbocharger 30 is a supplementary unit of the engine 1 that is apparent to a person of ordinary skill in the art, no more detailed description thereof will be provided.

The intercooler 40 is arranged on the connection passage 12. The intercooler 40 cools the outdoor air and the exhaust gas compressed by the compressor 32 and passed through the connection passage 12. The intercooler 40 is a water cooling type of intercooler. Therefore, the outdoor air and the exhaust gas compressed by the compressor 32 are cooled while the outdoor air and the exhaust gas pass through the intercooler 40 as the outdoor air and the exhaust gas exchange heat with the cooling water.

The cooling water passage 90 may be a cooling water passage of the cooling water which passes through a low temperature radiator 50 which disperses heat remaining in the low temperature cooling water to the air. The cooling water passage 90 is arranged to circulate cooling water while it passes through the low temperature radiator 50, the compressor 32, and the intercooler 40 in succession.

The water pump 70 is arranged on the cooling water passage 90 for pumping the cooling water to implement circulation of the cooing water. The water pump 70 may be arranged between the intercooler 40 and the low temperature radiator 50.

In FIG. 1, the cooling water passage 90 is shown with dashed lines, and a flow of the cooling water passing through the cooling water passage 90 is shown with arrows.

The cooling water passage 90 includes an inflow line 92 and an outflow line 94.

The inflow line 92 is formed such that the cooling water passed through the intercooler 40 and the low temperature radiator 50 is introduced to the compressor 32.

The outflow line 94 is formed such that the cooling water passed through the compressor 32 is discharged from the compressor 32. The cooling water discharged from the compressor 32 passes through the intercooler 40.

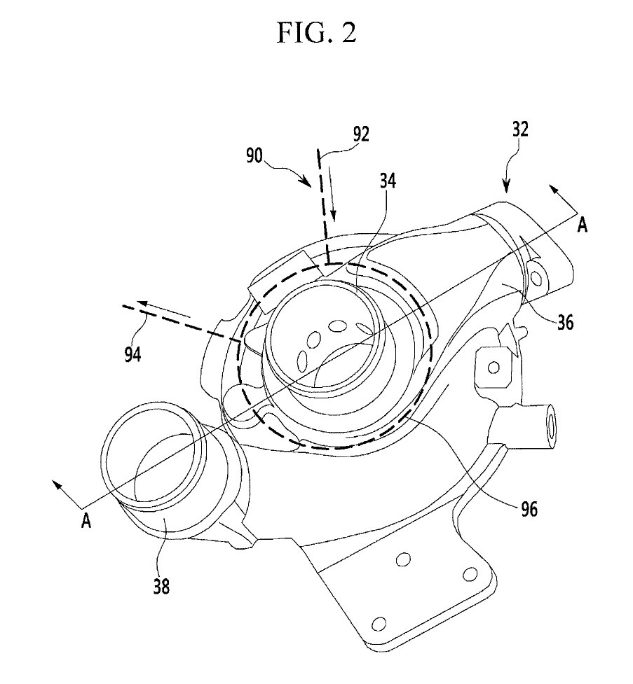

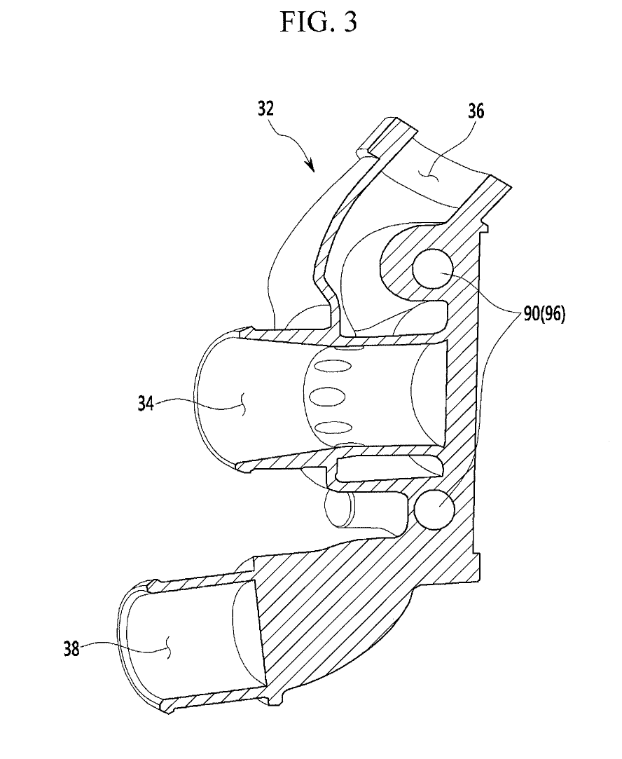

FIG. 2 illustrates a perspective view of a compressor in accordance with a exemplary embodiment of the present invention, and FIG. 3 illustrates a cross-sectional view across a line A-A in FIG. 2.

Referring to FIGS. 2 and 3, the compressor 32 includes an outdoor air inlet 34, an exhaust gas inlet 36, and an air outlet 38, and the cooling water passage 90 further includes a circulating line 96.

The outdoor air inlet 34 is formed to be connected to the intake passage 14 for the compressor 32 to receive the outdoor air introduced to the intake passage 14.

The exhaust gas inlet 36 is formed to be connected to the recirculation passage 24 for the compressor 32 to receive the recirculated exhaust gas introduced to the recirculation passage 24.

The air outlet 38 is formed to be connected to the connection passage 12 for discharging the outdoor air and the recirculated exhaust gas compressed as the outdoor air and the recirculated exhaust gas pass through the compressor 32. The outdoor air and the recirculated exhaust gas discharged through the air outlet 38 thus are introduced to the connection passage 12.

The circulating line 96 is formed to be in communication with the inflow line 92 and the outflow line 94 for the cooling water introduced to the compressor 32 through the inflow line 92 to circulate inside of the compressor 32. The cooling water circulated through the inside of the compressor 32 is discharged through the outflow line 94. Moreover, the circulating line 96 is formed in a body of the compressor 32 such that the cooling water passing through the circulating line 96 exchanges heat with the air passing through the outdoor air inlet 34, the exhaust gas inlet 36, and the air outlet 38 without flow interference with the air (the outdoor air and the recirculated exhaust gas) passing through the outdoor air inlet 34, the exhaust gas inlet 36, and the air outlet 38. Furthermore, the circulating line 96 may be a passage formed in a ring shape to surround the outdoor air inlet 34.

Thus, according to the exemplary embodiment of the present invention, since the cooling water passage 90 passes through the compressor 32 of the turbocharger 30, a separate additional EGR cooler may be eliminated. According to this, a production cost may be saved, weight may be reduced, and fuel consumption may be improved.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An intake air cooling system in an engine for cooling intake air being supplied to a cylinder of the engine, comprising:
an intake manifold provided for guiding the intake air to the cylinder;
a connection passage in communication with the intake manifold for introducing the intake air to the intake manifold;
an intake passage provided for receiving an outdoor air and in communication with the connection passage;
a compressor provided for compressing the outdoor air passed through the intake passage and forwarding the outdoor air compressed thus to the connection passage as the intake air;
an intercooler arranged on the connection passage for cooling the outdoor air compressed by the compressor with cooling water;
a low temperature radiator for dispersing heat remaining in the cooling water passed through the intercooler to air;
a cooling water passage arranged to circulate the cooling water while passing through the low temperature radiator, the compressor, and the intercooler in succession; and
a water pump for pumping the cooling water to circulate along the cooling water passage.

2. The system of claim 1, further comprising:
an exhaust manifold provided for receiving an exhaust gas from the cylinder;
an exhaust passage in communication with the exhaust manifold for exhausting the exhaust gas passed through the exhaust manifold; and
a recirculation passage which is a branch from the exhaust passage in communication with the connection passage for recirculating a portion of the exhaust gas passing through the exhaust passage as the intake air,
wherein the compressor compresses the outdoor air passed through the intake passage and a recirculated exhaust gas passed through the recirculation passage, and forwards the outdoor air and the recirculated exhaust gas compressed thus to the connection passage as the intake air, and
the intercooler cools the outdoor air and the recirculated exhaust gas compressed thus by the compressor.

3. The system of claim 1, wherein the cooling water passage includes:
an inflow line, wherein the cooling water passed through the intercooler and the low temperature radiator is introduced to the compressor through the inflow line;
an outflow line, wherein the cooling water passed through the compressor is discharged from the compressor through the outflow line; and
a circulating line formed to be in communication with the inflow line and the outflow line for the cooling water introduced to the compressor through the inflow line to circulate inside of the compressor.

4. The system of claim 3, wherein the circulating line is formed in a body of the compressor for the cooling water to exchange heat with the air passing through the compressor.

5. The system of claim 4, wherein the circulating line is a passage formed in a ring shape along the body of the compressor.

6. The system of claim 2, wherein the compressor includes:
an outdoor air inlet formed for receiving the outdoor air introduced to the intake passage;
an exhaust gas inlet formed for receiving the recirculated exhaust gas introduced to the recirculation passage; and
an air outlet formed for discharging the outdoor air and the recirculated exhaust gas compressed as the outdoor air, and the recirculated exhaust gas passes through the compressor to the connection passage.

7. The system of claim 6, wherein the cooling water passage forms an inflow line for introduction of the cooling water passed through the intercooler and the low temperature radiator to the compressor, an outflow line for discharging the cooling water passed through the compressor from the compressor, and a circulating line for the cooling water introduced to the compressor through the inflow line to circulate inside of the compressor.

8. The system of claim 7, wherein the circulating line is formed in the body of the compressor such that the cooling water passing through the circulating line exchanges heat with the air passing through the outdoor air inlet, the exhaust gas inlet, and the air outlet without flow interference with the air passing through the outdoor air inlet, the exhaust gas inlet, and the air outlet.
